(19) United States
(12) Patent Application Publication
(10) Pub. No.: US 2017/0369811 A1
(43) Pub. Date: Dec. 28, 2017

(54) LUBRICATING OIL COMPOSITION

(71) Applicant: IDEMITSU KOSAN CO., LTD., Chiyoda-ku (JP)

(72) Inventor: Moritsugu KASAI, Chiba-shi (JP)

(73) Assignee: IDEMITSU KOSAN CO., LTD., Chiyoda-ku (JP)

(21) Appl. No.: 15/543,843

(22) PCT Filed: Jan. 15, 2016
(86) PCT No.: PCT/JP2016/051189

§ 371 Date: Jul. 14, 2017

(30) Foreign Application Priority Data
Jan. 15, 2015 (JP) 2015-006081

(51) Int. Cl. C10M 161/00; C10M 101/00; F02M 61/14; C10M 169/04; C10M 145/14; C10M 149/06; C10M 155/04; F16J 9/20; C10M 139/00

(52) U.S. Cl. CPC C10M 161/00; F16J 9/20; C10M 101/00; F02M 61/14; C10M 139/00; C10M 145/14; C10M 149/06; C10M 155/04; C10M 169/044; C10M 2215/26; C10M 2209/108; C10M 2209/107; C10M 2209/084; C10M 2207/023; C10N 2240/10; C10M 2215/28; C10M 2217/024; C10M 2227/06; C10M 2227/09; C10M 2229/00; C10M 2205/02

(57) ABSTRACT

Provided is a lubricating oil composition to be used in an internal combustion engine having a sliding mechanism including a piston ring and a liner, the lubricating oil composition including: a base oil; (A) a poly(meth)acrylate; and (B) an organic molybdenum compound, in which: (A) the poly(meth)acrylate contains a polymer (A1) including a repeating unit derived from a (meth)acrylate represented by the following formula (1) and having a mass-average molecular weight of from 1,000 to 500,000; and a content of (B) the organic molybdenum compound in a total amount of the composition is from 0.01 mass % to 0.2 mass % in terms of a molybdenum atom: wherein R¹ represents a hydrogen atom or a methyl group, and X represents a hydrogen atom, a hydrocarbon group having 1 to 60 carbon atoms, or a functional group-containing hydrocarbon group having 1 to 60 carbon atoms.

### TECHNICAL FIELD

The present invention relates to a lubricating oil composition, and more particularly, to a lubricating oil composition suitable for a reduction in friction of an internal combustion engine having a sliding mechanism including a piston ring and a liner.

### BACKGROUND ART

From the viewpoint of a reduction in environmental load, a reduction in amount of CO₂ to be exhausted from an automobile has been desired with a view to coping with global warming, and hence a lubricating oil for an internal combustion engine of an automobile or the like has been required to achieve a further improvement in fuel efficiency. With regard to the improvement in fuel efficiency of the lubricating oil for an internal combustion engine, the improvement of the lubricating oil in terms of composition and a reduction in viscosity thereof have been advanced for the purpose of reducing friction in a fluid lubrication region (e.g., Patent Documents 1 and 2). However, when the lubricating oil is merely reduced in viscosity, concern is raised about insufficient lubricity (increase in frictional wear) under a severe lubrication condition, such as sliding between a piston ring and a liner, and hence a further optimum formulation technology for the lubricating oil has been required.

### CITATION LIST

### Patent Document

Patent Document 1: JP 5044093 B2

Patent Document 2: JP 4643030 B2

### SUMMARY OF INVENTION

### Technical Problem

As described above, from the viewpoint of the improvement in fuel efficiency of the lubricating oil for an internal combustion engine, an investigation on the reduction in viscosity thereof has been advanced for reducing a frictional resistance in the fluid lubrication region (reducing the viscosity in a practical region). However, in lubrication for the sliding between the piston ring and the liner, a fluid lubrication region and a boundary lubrication region are mixed. Accordingly, when an engine oil is merely reduced in viscosity, boundary lubrication becomes dominant and hence concern is raised about an increase in frictional resistance. In view of the foregoing, a lubricating oil composition of optimum formulation that can impart an excellent low friction characteristic to a sliding portion between the piston ring and the liner has been required.

That is, an object of the present invention is to provide a lubricating oil composition suitable for a reduction in friction of a sliding mechanism including a piston ring and a liner in an internal combustion engine having the sliding mechanism.

### Solution to Problem

The inventors of the present invention have made extensive investigations in view of the object, and as a result, have found the following. When a lubricating oil composition containing a lubricating oil base oil, (A) a specific poly(meth)acrylate, and (B) an organic molybdenum compound is used as a lubricating oil composition, the composition has a frictional resistance-reducing effect in each of a fluid lubrication region and a boundary lubrication region, and hence can improve lubricity. As a result, even when the composition is used in an internal combustion engine having a sliding mechanism including a piston ring and a liner, the composition can significantly reduce a frictional resistance in correspondence with an increase in heat load of the engine, and hence can maintain lubricity. Thus, the inventors have completed the present invention.

That is, the present invention is as described below.

[1] A lubricating oil composition to be used in an internal combustion engine having a sliding mechanism including a piston ring and a liner, the lubricating oil composition comprising:

a base oil;

(A) a poly(meth)acrylate and

(B) an organic molybdenum compound,

wherein:

(A) the poly(meth)acrylate contains a polymer (A1) including a repeating unit derived from a (meth)acrylate represented by the following formula (1) and having a mass-average molecular weight of from 1,000 to 500,000; and

a content of (B) the organic molybdenum compound in a total amount of the composition is from 0.01 mass % to 0.20 mass % in terms of a molybdenum atom;

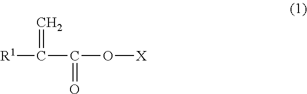

wherein R¹ represents a hydrogen atom or a methyl group, and X represents a hydrogen atom, a hydrocarbon group having 1 to 60 carbon atoms, or a functional group-containing hydrocarbon group having 1 to 60 carbon atoms.

[2] An internal combustion engine, comprising a sliding mechanism including a piston ring and a liner, wherein the lubricating oil composition of Item [1] is present in a sliding portion of the sliding mechanism.

[3] An internal combustion engine-lubricating method for lubricating a sliding mechanism including a piston ring and a liner in an internal combustion engine, the method comprising lubricating the piston ring and the liner with the lubricating oil composition of Item [1].

### Advantageous Effects of Invention

According to the present invention, the lubricating oil composition suitable for a reduction in friction of a sliding mechanism including a piston ring and a liner in an internal combustion engine having the sliding mechanism can be provided.

### BRIEF DESCRIPTION OF DRAWINGS

FIG. 1 is a schematic view for illustrating the outline of a floating liner friction tester configured to measure a fractional force between a piston ring and a liner.

### DESCRIPTION OF EMBODIMENTS

This embodiment is described in more detail below.

### [Lubricating Oil Composition]

A lubricating oil composition of this embodiment is a lubricating oil composition to be used in an internal combustion engine having a sliding mechanism including a piston ring and a liner, the lubricating oil composition comprising:

a base oil;

(A) a poly(meth)acrylate; and

(B) an organic molybdenum compound,

wherein:

(A) the poly(meth)acrylate contains a polymer (A1) including a repeating unit derived from a (meth)acrylate represented by the following formula (1) and having a mass-average molecular weight of from 1,000 to 500,000; and

a content of (B) the organic molybdenum compound in a total amount of the composition is from 0.01 mass % to 0.20 mass % in terms of a molybdenum atom:

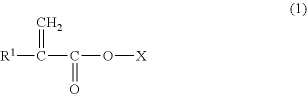

wherein R¹ represents a hydrogen atom or a methyl group, and X represents a hydrogen atom, a hydrocarbon group having 1 to 60 carbon atoms, or a functional group-containing hydrocarbon group having 1 to 60 carbon atoms.

### <Base Oil>

The base oil to be used in the lubricating oil composition of this embodiment is not particularly limited, and base oils formed of mineral oils and/or synthetic oils may each be used. The kinematic viscosity of the base oil at 100° C. is preferably 10 mm²/s or less, more preferably 7 mm²/s or less. When the kinematic viscosity at 100° C. is 10 mm²/s or less, an improvement in fuel efficiency can be achieved without any increase in coefficient of friction in a fluid lubrication region. Meanwhile, the kinematic viscosity at 100° C. is preferably 1.5 mm²/s or more, more preferably 2.5 mm²/s or more. When the kinematic viscosity at 100° C. is 1.5 mm²/s or more, lubricity, such as wear resistance, required in a sliding portion of an internal combustion engine, such as a valve train, a piston, a ring, or a bearing, can be secured.

Examples of the mineral oil-based base oils include: a base oil obtained by refining a fraction, which is obtained by the atmospheric distillation of a crude oil or by the vacuum distillation of an atmospheric residue obtained by the atmospheric distillation, through the performance of one or more treatments, such as solvent deasphalting, solvent extraction, hydrocracking, solvent dewaxing, and hydrorefining; and a base oil produced by isomerizing a mineral oil-based wax or a wax (gas-to-liquid wax) produced by a Fischer-Tropsch process or the like.

The viscosity index of any such mineral oil-based base oil is preferably 90 or more, more preferably 100 or more, still more preferably 120 or more. When the viscosity index is equal to or more than the above-mentioned value, a reduction in low-temperature viscosity of the composition can improve fuel efficiency and increase the high-temperature viscosity thereof. Accordingly, lubricity at high temperatures can be secured. The viscosity index may be measured in conformity with JIS K 2283.

In addition, the aromatic content (% C_{A}) of any such mineral oil-based base oil is preferably 3.0 or less, more preferably 2.0 or less, still more preferably 1.0 or less. The sulfur content thereof is preferably 100 ppm by mass or less, more preferably 50 ppm by mass or less. When the aromatic content is 3.0 or less and the sulfur content is 100 ppm by mass or less, the oxidation stability of the composition can be kept satisfactory.

Meanwhile, examples of the synthetic oil base oils include: polybutene or a hydrogenated product thereof; poly-α-olefin, such as a 1-decene oligomer, or a hydrogenated product thereof; diesters, such as di-2-ethylhexyl adipate and di-2-ethylhexyl sebacate; polyol esters, such as trimethylolpropane caprylate and pentaerythritol-2-ethyl hexanoate; aromatic synthetic oils, such as an alkylbenzene and an alkyl naphthalene; polyalkylene glycols; and mixtures thereof.

In this embodiment, for example, the mineral oil-based base oils or the synthetic oil base oils, or any mixtures each containing two or more selected from these base oils may each be used as the base oil.

The content of the base oil in the lubricating oil composition of this embodiment is preferably 60 mass % or more, more preferably 70 mass % or more, still more preferably 75 mass % or more, and is preferably 98 mass % or less, more preferably 95 mass % or less, still more preferably 90 mass % or less.

### (A) Poly(meth)acrylate

The lubricating oil composition of this embodiment contains (A) the poly(meth)acrylate containing the polymer (A1) including a repeating unit derived from the (meth)acrylate represented by the following formula (1) and having a mass-average molecular weight of 1,000 or more and 500,000 or less in order that an excellent friction-reducing effect may be imparted particularly in the sliding mechanism including the piston ring and the liner:

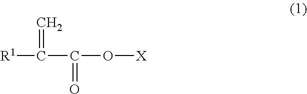

wherein R¹ represents a hydrogen atom or a methyl group, and X represents a hydrogen atom, a hydrocarbon group having 1 to 60 carbon atoms, or a functional group-containing hydrocarbon group having 1 to 60 carbon atoms.

In this description, the poly(meth)acrylate refers to polyacrylate and/or polymethacrylate.

(A) The poly (meth)acrylates may be used alone or in combination thereof.

X in the formula (1) preferably represents a hydrocarbon group having 1 to 30 carbon atoms, or a group represented by any one of the following formulae (i), (ii), (iii), and (iv):

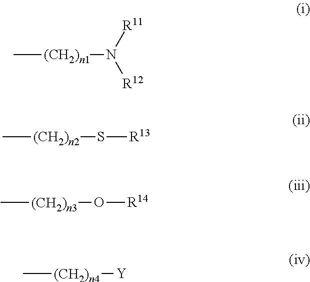

wherein:

R¹¹ to R¹⁴ each independently represent a hydrogen atom, a linear hydrocarbon group having 1 to 30 carbon atoms, a branched hydrocarbon group having 1 to 30 carbon atoms, a heteroatom-containing linear hydrocarbon group having 1 to 30 carbon atoms, or a heteroatom-containing branched hydrocarbon group having 1 to 30 carbon atoms;

n1 to n4 each independently represent an integer of from 1 to 30; and

Y represents an aryl group, a heterocyclic group, an ester group, an amide group, or a carbamate group.

The polymer (A1) in (A) the poly(meth)acrylate is preferably the following (A11) and/or (A12). Detailed description is given below.

It is preferred that (A) the poly(meth)acrylate contain a polymer (A11) having a unit derived from a functional group-containing (meth)acrylate (a) in which X in the formula (1) represents a group represented by any one of the formulae (i), (ii), (iii), and (iv). In the (A11), X in the formula (1) more preferably has a group represented by the formula (iii), still more preferably has a group represented by the formula (iii) in which R¹⁴ represents a hydrogen atom, and, particularly preferably has a group represented by the formula (iii) in which R¹⁴ represents a hydrogen atom and n3 represents from 1 to 5. The content of the polymer (A11) in (A) the poly(meth)acrylate is preferably from 70 mass % to 100 mass %, more preferably from 80 mass % to 100 mass %, still more preferably from 90 mass % to 100 mass %.

In addition, it is preferred that (A) the poly(meth)acrylate contain a copolymer (A12) having a unit derived from the functional group-containing (meth)acrylate (a) in which X in the formula (1) is represented by the formula (i), (ii), (iii), or (iv), and a unit derived from a hydrocarbyl (meth)acrylate (b) in which X in the formula (1) represents a hydrocarbon group having 1 to 30 carbon atoms. The copolymerization ratio [(a)/(b)] of the unit derived from the functional group-containing (meth)acrylate (a) to the unit derived from the hydrocarbyl (meth)acrylate (b) is preferably from 10:90 to 90:10, more preferably from 20:80 to 80:20, particularly preferably from 30:70 to 70:30.

The content of the copolymer (A12) in (A) the poly(meth)acrylate is preferably from 70 mass % to 100 mass %, more preferably from 80 mass % to 100 mass %, still more preferably from 90 mass % to 100 mass %.

When (A) the poly(meth)acrylate contains both the polymer (A11) and the copolymer (A12), the total content of the polymer (A11) and the copolymer (A12) in (A) the poly(meth)acrylate is adjusted to preferably from 70 mass % to 100 mass %, more preferably from 80 mass % to 100 mass %, still more preferably from 90 mass % to 100 mass %.

The polymer (A1) except the polymer (A11) and the copolymer (A12) is, for example, a polymer (poly(meth)acrylate) formed only of a (meth)acrylate unit in which X represents a hydrocarbon alkyl group having 1 to 60 carbon atoms, the polymer being generally used as a viscosity index improver or a pour-point depressant.

The mass-average molecular weight (Mw) may be measured by, for example, the following method. That is, a mass-average molecular weight in terms of a polystyrene is measured by a gel permeation chromatography (GPC) method with the following apparatus under the following conditions, and the measured value may be defined as the mass-average molecular weight (Mw).

### <GPC Measurement Apparatus>

Column: Shodex LF-404
Detector: RI detector for liquid chromatogram WATERS 150C

### <Measurement Conditions>

Solvent: chloroform
Measurement temperature: 40° C.
Flow rate: 0.3 ml/min
Sample concentration: 0.2 mg/ml
Injection volume: 5 μl

The mass-average molecular weight of (A) the poly(meth)acrylate is 1,000 or more and 500,000 or less. When the mass-average molecular weight is less than 1,000, a friction-reducing effect particularly in the sliding mechanism including the piston ring and the liner is low. When the mass-average molecular weight is more than 500,000, it is difficult to obtain a friction-reducing effect at high temperatures, and hence it is difficult to stably maintain the effect. From the foregoing viewpoint, the mass-average molecular weight of (A) the poly(meth)acrylate is preferably 5,000 or more and 200,000 or less, more preferably 10,000 or more and 120,000 or less, still more preferably 20,000 or more and 80,000 or less, particularly preferably 20,000 or more and 70,000 or less, most preferably 30,000 or more and 70,000 or less.

The content of (A) the poly(meth)acrylate is preferably selected from the range of from 0.01 mass % or more to 10 mass % or less with respect to the total amount of the composition. When the content is 0.01 mass % or more, an excellent friction-reducing effect particularly in the sliding mechanism including the piston ring and the liner is obtained. When the content is 10 mass % or less, an excellent friction-reducing effect is obtained without the occurrence of a problem in that the viscosity of the composition at low temperatures increases, and hence the effect can be stably maintained. From the above-mentioned viewpoint, the content of (A) the poly(meth)acrylate is more preferably 0.05 mass % or more and 5.0 mass % or less, still more preferably 0.1 mass % or more and 2.0 mass % or less with respect to the total amount of the composition.

### (B) Organic Molybdenum Compound

The lubricating oil composition of this embodiment contains (B) the organic molybdenum compound in order that an excellent friction-reducing effect may be imparted particularly in the sliding mechanism including the piston ring and the liner.

Examples of (B) the organic molybdenum compound include a molybdenum-amine complex, a molybdenum dithiocarbamate, a trinuclear molybdenum-sulfur compound, and a molybdenum dithiophosphate. Among them, a molybdenum dithiocarbamate is preferably used.

An example of the molybdenum dithiocarbamate is a compound represented by the following formula (2).

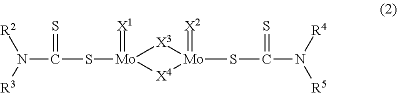

In the formula (2), R² to R⁵ each preferably represent a hydrocarbon group having 4 to 22 carbon atoms, and examples thereof include an alkyl group, an alkenyl group, an alkylaryl group, a cycloalkyl group, and a cycloalkenyl group. Among them, R² to R⁵ each preferably represent a branched or linear alkyl group or alkenyl group having 4 to 18 carbon atoms, and each more preferably represent an alkyl group having 8 to 13 carbon atoms in terms of the solubility of the compound in the base oil and the ease with which the compound is used. Examples of such alkyl group include a n-octyl group, a 2-ethylhexyl group, an isononyl group, a n-decyl group, an isodecyl group, a dodecyl group, a tridecyl group, and an isotridecyl group. R² to R⁵ may be identical to each other, or may be different from each other. However, when R² and R³, and R⁴ and R⁵ represent different alkyl groups, the solubility in the base oil, the storage stability of the composition, and the persistence of its friction-reducing ability are improved.

In addition, in the formula (2), X¹ to X⁴ each represent a sulfur atom or an oxygen atom, and all of X¹ to X⁴ may represent sulfur atoms or oxygen atoms. Here, a ratio “sulfur atom/oxygen atom” of a sulfur atom to an oxygen atom is preferably from 1/3 to 3/1, more preferably from 1.5/2.5 to 3/1 in terms of the corrosion resistance of the composition and the improvement of the solubility in the base oil.

The components (B) may be used alone or in combination thereof.

The content of (B) the organic molybdenum compound in the lubricating oil composition of this embodiment is from 0.01 mass % to 0.20 mass %, preferably from 0.015 mass % to 0.15 mass %, more preferably from 0.02 mass % to 0.12 mass %, still more preferably from 0.03 mass % to 0.10 mass %, particularly preferably from 0.04 mass % to 0.10 mass % in terms of a molybdenum atom in the total amount of the composition. When the content of (B) the organic molybdenum compound is 0.01 mass % or more in terms of a molybdenum atom in the total amount of the composition, a friction-reducing effect particularly in the sliding mechanism including the piston ring and the liner, especially a friction-reducing effect in a mixed lubrication region is improved. When the content is 0.20 mass % or less, a friction-reducing effect commensurate with the content is obtained.

The content of (B) the organic molybdenum compound is measured in conformity with JPI-5S-38-92.

In addition, in the lubricating oil composition of this embodiment, a mass ratio [content of (A) poly(meth)acrylate/content (in terms of molybdenum atom) of (B) organic molybdenum compound] of the content (mass %) of (A) the poly(meth)acrylate to the content (in terms of a molybdenum atom, mass %) of (B) the organic molybdenum compound is preferably from 1.0 to 50, more preferably from 2.0 to 40, still more preferably from 2.5 to 30. When the mass ratio of the content of (A) the poly(meth)acrylate to the content (in terms of a molybdenum atom) of (B) the organic molybdenum compound falls within the range, the composition easily expresses satisfactory wear resistance even in a situation where the amount of carbon soot in an oil has increased.

### (C) Organic Phosphorus Compound

The lubricating oil composition of this embodiment preferably further contains (C) an organic phosphorus compound.

(C) The organic phosphorus compound is preferably a metal dialkyldithiophosphate (containing Zn, Pb, Sb, Mo, or the like), more preferably a zinc dialkyldithiophosphate or a zinc dialkyldioxophosphate, particularly preferably a zinc dialkyldithiophosphate, especially preferably a compound represented by the following formula (3):

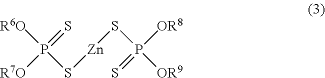

wherein R⁶ to R⁹ each independently represent any one selected from a linear, branched, or cyclic alkyl group having 6 to 20 carbon atoms, and a linear, branches, or cyclic alkenyl group having 6 to 20 carbon atoms.

The number of carbon atoms of the alkyl group or the alkenyl group represented by each of R⁶ to R⁹ in the formula (3) is preferably from 8 to 18, more preferably from 10 to 14, still more preferably 12. In addition, R⁶ to R⁹ in the formula (3) each preferably represent an alkyl group.

Examples of the alkyl group in R⁶ to R⁹ include a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, an octadecyl group, a nonadecyl group, and an icosyl group. The alkyl group may be linear, branched, or cyclic. Examples of the alkenyl group include a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, and an icosenyl group. The alkenyl group may be linear, branched, or cyclic, and the position of the double bond is also arbitrary.

In the formula (3), R⁶ to R⁹ may be identical to or different from each other, but are preferably identical to each other from the viewpoint of ease of production.

Among them, a dodecyl group, such as a lauryl group, a tetradecyl group, a hexadecyl group, an octadecyl group, such as a stearyl group, an icosyl group, and an octadecenyl group, such as an oleyl group, are preferred, and a lauryl group is most preferred.

The zinc dialkyldithiophosphates may be used alone or in combination thereof.

The total content of (C) the organic phosphorus compound in the lubricating oil composition of this embodiment is preferably from 0.1 mass % to 10 mass %, more preferably from 0.5 mass % to 5.0 mass %, still more preferably from 1.0 mass % to 3.0 mass % with respect to the total amount of the composition.

### <Metal-Based Detergent>

The lubricating oil composition of this embodiment preferably contains a metal-based detergent. Examples of the metal-based detergent include sulfonates, phenates, salicylates, and naphthenates of alkali metals (e.g., sodium (Na) and potassium (K)) or alkaline earth metals (e.g., calcium (Ca), magnesium (Mg), and barium (Ba)). In this embodiment, one or more of metal-based detergents selected from alkaline earth metal-based detergents, especially a calcium (Ca)-based detergent and a magnesium (Mg)-based detergent are preferably used as the metal-based detergent, and sulfonates, phenates, and salicylates thereof are particularly preferably used. Those detergents can be used alone or in combination thereof.

The metal-based detergent may be any one of a neutral salt, a basic salt, and a perbasic salt. The total base number and content of any such metal-based detergent may be arbitrarily selected in accordance with required lubricating oil performance. The total base number of the metal-based detergent is typically 500 mgKOH/g or less, preferably 20 mgKOH/g or more and 400 mgKOH/g or less on the basis of a perchloric acid method. In addition, the content of the metal-based detergent is typically 0.1 mass % or more and 10 mass % or less with respect to the total amount of the lubricating oil composition, and its total amount in terms of a metal atom derived from the metal-based detergent with respect to the total amount of the lubricating oil composition is 0.05 mass % or more and 0.40 mass % or less, preferably 0.10 mass % or more and 0.30 mass % or less, more preferably 0.10 mass % or more and 0.25 mass % or less, still more preferably 0.12 mass % or more and 0.23 mass % or less. When the content of the metal-based detergent falls within the range, the composition easily expresses satisfactory wear resistance even in a situation where the amount of carbon soot in an oil has increased.

The term “total base number” as used herein means a total base number based on a potentiometric titration method (base number/perchloric acid method) measured in conformity with 7. of JIS K 2501 “Petroleum Product and Lubricants—Determination of Neutralization”

<Polybutenyl Succinimide and/or Polybutenyl Succinimide Boride>

The lubricating oil composition of this embodiment preferably contains a polybutenyl succinimide and/or a polybutenyl succinimide boride as an ashless dispersant.

The polybutenyl succinimide is obtained by causing a polybutenyl succinic anhydride, which has a polybutenyl group having a number-average molecular weight of 900 or more and 3,500 or less, and is typically obtained by a reaction between a polybutene and maleic anhydride, or an alkyl succinic anhydride obtained by hydrogenating the anhydride to react with a polyamine.

Examples of the polyamine may include: single diamines, such as ethylenediamine, propylenediamine, butylenediamine, and pentylenediamine; polyalkylene polyamines, such as diethylenetriamine, triethylenetetramine, tetraethylenepentamine, pentaethylenehexamine, di(methylethylene)triamine, dibutylenetriamine, tributylenetetramine, and pentapentylenehexamine; and piperazine derivatives, such as aminoethylpiperazine.

In addition, not only the polybutenyl succinimide but also a boride thereof and/or a product obtained by modifying the polybutenyl succinimide or the boride with an organic acid may be used. A boride produced by a normal method may be used as the polybutenyl succinimide boride. The polybutenyl succinimide boride is obtained by, for example, producing a polybutenyl succinic anhydride as described above, and then further causing the anhydride and an intermediate, which is obtained by causing the above-mentioned polyamine and a boron compound, such as boron oxide, a boron halide, boric acid, boric anhydride, a borate, or an ammonium salt of boric acid, to react with each other, to react with each other to imidize the anhydride.

The polybutenyl succinimides and/or the polybutenyl succinimide borides may be used alone or in combination thereof.

The content of the polybutenyl succinimide and/or the polybutenyl succinimide boride is preferably 0.5 mass % or more and 15 mass % or less, more preferably 1 mass % or more and 10 mass % or less with respect to the total amount of the lubricating oil composition. When the content falls within the range, even in a situation where the amount of carbon soot in an oil has increased, the composition easily expresses satisfactory wear resistance, and a wear resistance-improving effect is prevented from being reduced by any other additive. The total content of the polybutenyl succinimide and/or the polybutenyl succinimide boride is preferably 0.02 mass % or more and 0.40 mass % or less, more preferably 0.04 mass % or more and 0.40 mass % or less, still more preferably 0.04 mass % or more and 0.15 mass % or less in terms of the content of nitrogen derived from the succinimide compound with respect to the total amount of the lubricating oil composition. Further, when the succinimide compound contains a boride thereof, the content of boron derived from the boride is preferably 0.005 mass % or more and 0.3 mass % or less, more preferably 0.01 mass % or more and 0.3 mass % or less, particularly preferably 0.01 mass % or more and 0.08 mass % or less with respect to the total amount of the composition. When the boron content falls within the range, satisfactory detergency and satisfactory dispersibility can be obtained.

### <Other Additives>

The lubricating oil composition of this embodiment may be further blended with an antiwear additive, an extreme pressure agent, an antioxidant, a friction modifier, a pour-point depressant, a rust inhibitor, a deactivator, a defoaming agent, or the like in addition to the above-mentioned various additives. In addition, the composition may contain a viscosity index improver, a friction-reducing agent, or the like except (A) the poly(meth)acrylate, (B) the organic molybdenum compound, and (C) the organic phosphorus compound.

Any agent appropriately selected from known antiwear additives and extreme pressure agents that have heretofore been used in engine oils may be used as the antiwear additive or the extreme pressure agent. Examples thereof include metal (e.g., Zn, Pb, Sb, and Mo) dithiocarbamates, metal (e.g., Pb) naphthenates, metal (e.g., Pb) salts of fatty acids, boron compounds, phosphates, phosphites, alkyl hydrogen phosphites, phosphate amine salts, phosphate metal (e.g., Zn) salts, disulfides, sulfurized oils and fats, sulfurized olefins, dialkyl polysulfides, diaryl alkyl polysulfides, and diaryl polysulfides. Although those antiwear additives and extreme pressure agents may be used alone or in any combination thereof, the content of any such agent typically falls within the range of from 0.1 mass % or more to 5 mass % or less with respect to the total amount of the lubricating oil composition.

Any antioxidant appropriately selected from known antioxidants that have heretofore been used in engine oils may be used as the antioxidant, and a phenol-based antioxidant, an amine-based antioxidant, a molybdenum-based antioxidant, a sulfur-based antioxidant, a phosphorus-based antioxidant, or the like may be suitably used. Specific examples thereof include: amine-based antioxidants, such as an alkylated diphenylamine, phenyl-α-naphthylamine, and an alkylated phenyl-α-naphthylamine; phenol-based antioxidants, such as 2,6-di-tert-butylphenol, 4,4′-methylenebis(2,6-di-tert-butyl-phenol), isooctyl-3-(3,5-di-tert-butyl-4-hydroxyphenyl)propionate, and octadecyl-3-(3,5-di-tert-butyl-4-hydroxyphenyl)propionate; sulfur-based antioxidants, such as dilauryl-3,3′-thiodipropionate; phosphorus-based antioxidants, such as a phosphite; and molybdenum-based antioxidants. Although those antioxidants may be used alone or in any combination thereof, a combination of two or more thereof is preferred in normal cases. The content of any such antioxidant is preferably 0.01 mass % or more and 5 mass % or less, more preferably 0.2 mass % or more and 3 mass % or less with respect to the total amount of the lubricating oil composition.

Examples of the friction modifier include fatty acids, higher alcohols, oils and fats, amides, sulfurized esters, phosphates, phosphites, and phosphate amine salts. Although those friction modifiers may be used alone or in any combination thereof, the content of any such modifier typically falls within the range of from 0.05 mass % or more to 4.0 mass % or less with respect to the total amount of the lubricating oil composition.

Examples of the pour-point depressant include an ethylene-vinyl acetate copolymer, a condensate of a chlorinated paraffin and naphthalene, a condensate of a chlorinated paraffin and phenol, a polymethacrylate, and a polyalkylstyrene. The content of any such pour-point depressant typically falls within the range of from 0.01 mass % or more to 5 mass % or less with respect to the total amount of the lubricating oil composition.

Examples of the rust inhibitor include a fatty acid, an alkenyl succinic acid half ester, a fatty acid soap, an alkyl sulfonate, a fatty acid amine, paraffin oxide, and an alkyl polyoxyethylene ether. The content of any such rust inhibitor typically falls within the range of from 0.01 mass % or more to 5 mass % or less with reference to the lubricating oil composition.

Examples of the metal deactivator include benzotriazole, triazole derivatives, benzotriazole derivatives, and thiadiazole derivatives. The content of any such metal deactivator typically falls within the range of from 0.01 mass % or more to 3 mass % or less with reference to the total amount of the lubricating oil composition.

Examples of the defoaming agent include dimethylpolysiloxane and polyacrylate.

### <Lubricating Oil Composition>

The lubricating oil composition of this embodiment contains the above-mentioned base oil and the above-mentioned essential components, and as required, the above-mentioned various additives.

In the lubricating oil composition of this embodiment, a phosphorus content is preferably 0.18 mass % or less with respect to the total amount of the lubricating oil composition. In normal cases, the phosphorus content in the composition may be desirably large to some extent from the viewpoint of, for example, wear resistance. Meanwhile, a reduction in amount of a phosphorus-containing compound is desired from the viewpoint of a reduction in environmental load. In this embodiment, an excellent friction-reducing effect can be exhibited even when the phosphorus content is as low as 0.18 mass % or less. From the foregoing viewpoints, the phosphorus content is more preferably 0.15 mass % or less, still more preferably 0.12 mass % or less with respect to the total amount of the lubricating oil composition. In addition, the phosphorus content is preferably more than 0.04 mass %, more preferably 0.05 mass % or more, particularly preferably 0.06 mass % or more with respect to the total amount of the lubricating oil composition.

The phosphorus content only needs to be adjusted by the addition amount of the phosphorous-containing additive. A typical phosphorus-based antiwear additive is, for example, a phosphate- or thiophosphate-based antiwear additive, in particular, a zinc dithiophosphate (ZnDTP). The usage or addition amount of any such additive may be appropriately adjusted.

In addition, the sulfated ash content of the lubricating oil composition of this embodiment is preferably 1.5 mass % or less, more preferably 1.3 mass % or less, still more preferably 1.2 mass % or less. When the sulfated ash content of the lubricating oil composition falls within the range, a poisoning action on an active site of a three-way catalyst can be suppressed, and hence the lifetime of the catalyst can be extended.

The kinematic viscosity of the lubricating oil composition of this embodiment at 40° C. is preferably 10 mm²/s or more and 100 mm²/s or less, more preferably 20 mm²/s or more and 100 mm²/s or less, still more preferably 30 mm²/s or more and 80 mm²/s or less, particularly preferably 40 mm²/s or more and 70 mm²/s or less. In addition, the kinematic viscosity thereof at 100° C. is preferably 2.5 mm²/s or more and 30 mm²/s or less, more preferably 4 mm²/s or more and 20 mm²/s or less, still more preferably 5 mm²/s or more and 15 mm²/s or less, particularly preferably 5 mm²/s or more and 11 mm²/s or less. The case where the kinematic viscosity at 40° C. or 100° C. falls within the range is preferred because an excellent friction-reducing effect is obtained.

In addition, the viscosity index of the lubricating oil composition of this embodiment is preferably 120 or more. When the viscosity index is 120 or more, a reduction in low-temperature viscosity of the composition can improve fuel efficiency and increase the high-temperature viscosity thereof. Accordingly, lubricity at high temperatures can be secured. From the above-mentioned viewpoint, the viscosity index of the lubricating oil composition of this embodiment is more preferably 140 or more, still more preferably 160 or more, particularly preferably 170 or more. The kinematic viscosities and the viscosity index may be measured in conformity with JIS K 2283.

The lubricating oil composition of this embodiment is preferably used in a direct-injection engine including cylinder fuel-injecting means, is more preferably used in a direct-injection supercharged engine including the cylinder fuel-injecting means and a supercharger, and is most preferably used in a direct-injection supercharged gasoline engine including the cylinder fuel-injecting means and the supercharger.

In recent years, the following has been advanced for reductions in size and weight of a gasoline engine; the engine is turned into a direct-injection supercharged engine. However, the inventors of the present invention have found that in a direct-injection engine, especially a direct-injection supercharged engine, the amount of carbon soot in an engine oil increases to reduce a wear resistance-improving effect exhibited by a molybdenum-based compound.

In contrast, the lubricating oil composition of this embodiment is suitable for the above-mentioned application because the composition expresses satisfactory wear resistance even in a situation where the amount of the carbon soot in the oil has increased.

Meanwhile, the lubricating oil composition of this embodiment is also preferably used in an engine including an exhaust gas recirculation (EGR) apparatus, and is more preferably used in a diesel engine including the exhaust gas recirculation (EGR) apparatus.

This is because of the following reason. As in the above-mentioned direct-injection engine or the like, also in the diesel engine including the EGR, the amount of carbon soot in an engine oil tends to be liable to increase. The lubricating oil composition of this embodiment is suitable also for this application because the composition expresses satisfactory wear resistance even in a situation where the amount of the carbon soot in the oil has increased.

### <Frictional Energy of Lubricating Oil Composition>

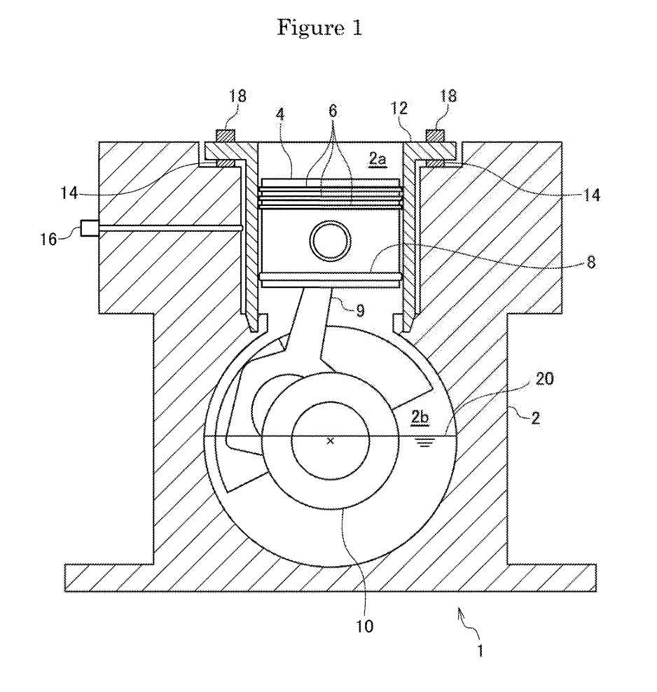

In this embodiment, the frictional energy of the lubricating oil composition may be measured with a floating liner friction tester illustrated in FIG. 1. The floating liner friction tester illustrated in FIG. 1 is described below.

A floating liner friction tester 1 of FIG. 1 includes: a block 2 having a piston-moving path 2a and a crankshaft-housing space 2b; a liner 12 arranged along the inner wall of the piston-moving path 2a; a piston 4 stored in the liner 12; piston rings 6 and 8 fit onto the piston 4; a crankshaft 10 housed in the crankshaft-housing space 2b; a connecting rod 9 configured to connect the crankshaft 10 and the piston 4; and a load-measuring sensor 14 sandwiched between the liner 12 and the piston-moving path 2a, the sensor being configured to measure a frictional force applied between each of the piston rings 6 and the liner 12 by the piston reciprocating motion of the piston 4.

The crankshaft 10 is rotationally driven by a motor (not shown) to reciprocate the piston 4 through the connecting rod 9.

The load-measuring sensor 14 is fixed to the liner 12 through fixing screws 18. The floating liner friction tester 1 may include a temperature gauge 16 for measuring the temperature of the liner 12 as illustrated in FIG. 1.

In the floating liner friction tester 1, the frictional force applied between each of the piston rings 6 and the liner 12 by the motion of the piston 4 is measured by the load-measuring sensor 14.

In the floating liner friction tester 1 formed as described above, a lubricating oil composition 20 is filled into the crankshaft-housing space 2b until its liquid level becomes higher than the center of the central axis of the crankshaft 10 and lower than the uppermost end of the central axis. The lubricating oil composition 20 in the crankshaft-housing space 2b is supplied to a space between the liner 12 and each of the piston rings 6 according to a splash system by the rotating crankshaft 10.

In the lubricating oil composition of this embodiment, a frictional energy at a liner temperature of 90° C. measured with the floating liner friction tester 1 having the following specifications under the following measurement conditions is preferably 4.6 J/rotation or less, more preferably 4.4 J/rotation or less, still more preferably 4.2 J/rotation or less from the viewpoint of reducing the friction of a sliding mechanism.

### <Specifications of Floating Liner Friction Tester 1>

Test apparatus: electric motor-driven floating liner friction tester
Displacement: 315 cm³ (single cylinder)
Ring material: steel material (surface treated with CrN coating)
Liner material: FC250 cast iron

### <Measurement Conditions for Floating Liner Friction Tester 1>

Liner temperature: 90° C.

Number of rotations: 900 rpm

Measurement item: frictional force applied to a liner portion (unit: N)

Evaluation item: frictional energy per rotation calculated from the frictional force (unit: J/rotation)

### [Method of Producing Lubricating Oil Composition]

The lubricating oil composition of this embodiment may be produced by blending the base oil described above with (A) the poly(meth)acrylate described above and (B) the organic molybdenum compound described above.

Details about those essential components are as described above. In addition, the above-mentioned arbitrary components may be blended together with the essential components.

### [Use in Apparatus Having Sliding Mechanism Including Piston Ring and Liner]

The lubricating oil composition of this embodiment is suitable for the lubrication of a sliding mechanism including a piston ring and a liner, in particular, the sliding mechanism including the piston ring and the liner in an internal combustion engine because the composition has the above-mentioned action and effect.

Materials for the piston ring and the liner to which the lubricating oil composition of this embodiment is applied are not particularly limited, and a cast iron alloy as well as an aluminum alloy is typically adopted as a material for the liner. In addition, Si—Cr steel or martensite-based stainless steel containing 11 mass % to 17 mass % of Cr has been used as a material for the piston ring. In the piston ring, any such material is desirably further subjected to a surface treatment, such as a chromium plating treatment, a chromium nitride treatment, or a nitriding treatment, or a combination thereof. In this embodiment, from the viewpoints of an excellent friction-reducing effect, excellent adhesiveness, and excellent durability, the lubricating oil composition of this embodiment is preferably used in a sliding mechanism including a piston ring and a liner, the mechanism using a piston ring treated with chromium nitride, because the effect of this embodiment can be further improved.

This embodiment is preferably applied to a sliding mechanism including a piston ring and a liner in the internal combustion engine of an automobile from the viewpoint of a further improvement in fuel efficiency.

### [Internal Combustion Engine]

This embodiment also provides an internal combustion engine including a sliding mechanism including a piston ring and a liner, in which the lubricating oil composition of this embodiment is present in a sliding portion of the sliding mechanism. The internal combustion engine preferably includes cylinder fuel-injecting means, and preferably further includes a supercharger. The internal combustion engine more preferably includes the cylinder fuel-injecting means and the supercharger.

The lubricating oil composition of this embodiment, and the sliding mechanism including the piston ring and the liner are as described above. For example, the piston ring preferably has a sliding surface treated with chromium nitride.

[Method of Lubricating Internal Combustion Engine Having Sliding Mechanism Including Piston Ring and Liner]

This embodiment also relates to a lubrication method including lubricating an internal combustion engine having a sliding mechanism including a piston ring and a liner with the lubricating oil composition of this embodiment.

The lubricating oil composition of this embodiment, and the sliding mechanism including the piston ring and the liner are as described above. For example, the piston ring preferably has a sliding surface treated with chromium nitride.

In this embodiment, when the lubricating oil composition of this embodiment is used as a lubricating oil in a sliding portion between the piston ring and the liner, the composition significantly reduces the friction of the portion in each of fluid lubrication and mixed lubrication, and hence can contribute to an improvement in fuel efficiency.

### EXAMPLES

Next, this embodiment is specifically described by way of Examples, but the this embodiment is by no means limited thereto.

### [Evaluation Items and Evaluation Methods]

The properties of a lubricating oil were measured by the following methods.
(1) Kinematic viscosities (at 40° C. and 100° C.): in conformity with JIS K 2283
(2) Viscosity index: in conformity with JIS K 2283
(3) Molybdenum content: in conformity with JPI-5S-38-92
(4) Sulfated ash content: measured in conformity with JIS K 2272
(5) Phosphorus content: in conformity with JPI-5S-38-92
(6) Frictional energy: A frictional energy per rotation (unit: J/rotation) was calculated for each lubricating oil composition from a frictional force between a piston ring and a liner obtained with the floating liner friction tester illustrated in FIG. 1 under the following conditions.
   Test apparatus: electric motor-driven floating liner friction tester (FIG. 1)
      Displacement: 315 cm³ (single cylinder)
      Ring Material: steel material (surface treated with CrN coating)
      Liner material: FC250 cast iron
   Test conditions: liner temperature; 90° C., number of rotations; 900 rpm
   Measurement item: frictional force applied to a liner portion (unit: N)
   Evaluation item: frictional energy per rotation calculated from the frictional force (unit: J/rotation)
(7) Shell four-ball test (without carbon black): Each of lubricating oil compositions prepared in Examples 1 to 9 and Comparative Examples 1 to 6 was subjected to a test in conformity with ASTM D2783 by using a four-ball tester under the conditions of a load of 294 N, a number of revolutions of 1,200 rpm, an oil temperature of 80° C., and a test time of 30 minutes. An average wear track diameter was calculated by averaging the wear track diameters of three ½-inch balls.
(8) Shell four-ball test (with carbon black): A carbon black-containing lubricating oil composition was prepared by adding 3.0 parts by mass of carbon black (trade name: MA100, manufactured by Mitsubishi Chemical Corporation) to 97.0 parts by mass of each of the lubricating oil compositions prepared in Examples 1 to 9 and Comparative Examples 1 to 6. The composition was subjected to a test in conformity with ASTM D2783 by using a four-ball tester under the conditions of a load of 294 N, a number of revolutions of 1,200 rpm, an oil temperature of 80° C., and a test time of 30 minutes. An average wear track diameter was calculated by averaging the wear track diameters of three ½-inch balls.

### Examples 1 to 9 and Comparative Examples 1 to 6

As shown in Table 1, a base oil shown in the table was blended with various additives to prepare lubricating oil compositions. After that, the respective properties, such as kinematic viscosities (at 40° C. and 100° C.) and a viscosity index, of each of the resultant lubricating oil compositions were measured, and each of the compositions was evaluated for its frictional energy by a floating liner test. The results are shown in Table 1.

TABLE 1
Table 1-1

| | | | Example | | | | | | | | |
|---|---|---|---|---|---|---|---|---|---|---|---|
| | | | 1 | 2 | 3 | 4 | 5 | 6 | 7 | 8 | 9 |
| Lubricating | Base oil | Hydrorefined base oil 100 N | Balance | Balance | Balance | Balance | Balance | Balance | Balance | Balance | Balance |
| oil | Additive | Organic molybdenum compound | 0.40 | 0.40 | 1.00 | 0.20 | 0.40 | 0.40 | 0.40 | 0.40 | 0.40 |
| composition | | Poly(meth)acrylate 1 | 0.25 | | 0.25 | 0.25 | 1.00 | 0.25 | 0.25 | 0.25 | 0.25 |
| (mass %) | | Poly(meth)acrylate 2 | | 0.25 | | | | | | | |
| | | Amide-based friction-reducing agent | | | | | | | | | |
| | | Ester-based friction-reducing agent | | | | | | | | | |
| | | Ether-based friction-reducing agent | | | | | | | | | |
| | | Viscosity index improver | 7.50 | 7.50 | 7.50 | 7.50 | 7.50 | 7.50 | 7.50 | 7.50 | 7.50 |
| | | Zinc dialkyldithiophosphate A | 0.20 | 0.20 | 0.20 | 0.20 | 0.20 | 0.10 | 0.30 | 0.20 | 0.20 |
| | | Zinc dialkyldithiophosphate B | 1.20 | 1.20 | 1.20 | 1.20 | 1.20 | 0.60 | 1.80 | 1.20 | 1.20 |
| | | Antioxidant A | 0.50 | 0.50 | 0.50 | 0.50 | 0.50 | 0.50 | 0.50 | 0.50 | 0.50 |
| | | Antioxidant B | 0.50 | 0.50 | 0.50 | 0.50 | 0.50 | 0.50 | 0.50 | 0.50 | 0.50 |
| | | Metal-based detergent A | 1.20 | 1.20 | 1.20 | 1.20 | 1.20 | 1.20 | 1.20 | 0.48 | 1.80 |
| | | Metal-based detergent B | 1.00 | 1.00 | 1.00 | 1.00 | 1.00 | 1.00 | 1.00 | 0.40 | 1.50 |
| | | Polybutenyl succinic bisimide | 4.00 | 4.00 | 4.00 | 4.00 | 4.00 | 4.00 | 4.00 | 4.00 | 4.00 |
| | | Polybutenyl succinic bisimide boride | 1.00 | 1.00 | 1.00 | 1.00 | 1.00 | 1.00 | 1.00 | 1.00 | 1.00 |
| | | Other additives | 0.80 | 0.80 | 0.80 | 0.80 | 0.80 | 0.80 | 0.80 | 0.80 | 0.80 |
| Properties | Kinematic | 40° C. [mm²/s] | 55.1 | 44.9 | 55.2 | 55.1 | 58.6 | 55.1 | 55.1 | 55.0 | 55.4 |
| and | viscosity | 100° C. [mm²/s] | 10.3 | 10.2 | 10.3 | 10.3 | 10.6 | 10.3 | 10.2 | 10.2 | 10.30 |

| | | | | | | | | | | |
|---|---|---|---|---|---|---|---|---|---|---|
| performance | Viscosity index [—] | 178 | 177 | 178 | 178 | 173 | 178 | 176 | 176 | 177 |
| of | Molybdenum content [mass %] | 0.04 | 0.04 | 0.10 | 0.02 | 0.04 | 0.04 | 0.04 | 0.04 | 0.04 |
| lubricating | Sulfated ash content [mass %] | 1.06 | 1.06 | 1.07 | 1.03 | 1.06 | 0.92 | 1.20 | 0.62 | 1.43 |
| oil | Phosphorus content [mass %] | 0.11 | 0.11 | 0.11 | 0.11 | 0.11 | 0.06 | 0.17 | 0.11 | 0.11 |
| composition | Frictional energy at liner temperature of 90° C. | 4.1 | 4.1 | 4.0 | 4.2 | 4.0 | 4.1 | 4.2 | 4.1 | 4.2 |
| | [J/rotation] | | | | | | | | | |
| | Shell four-ball test (without carbon black) | 0.30 | 0.31 | 0.27 | 0.31 | 0.28 | 0.30 | 0.28 | 0.28 | 0.31 |
| | Shell four-ball test (with carbon black) | 0.36 | 0.35 | 0.32 | 0.37 | 0.33 | 0.38 | 0.32 | 0.35 | 0.38 |

TABLE 2
Table 1-2

| | | | Comparative Example | | | | | |
|---|---|---|---|---|---|---|---|---|
| | | | 1 | 2 | 3 | 4 | 5 | 6 |
| Lubricating oil composition | Base oil | Hydrorefined base oil 100 N | Balance | Balance | Balance | Balance | Balance | Balance |
| (mass %) | Additive | Organic molybdenum compound | | 0.40 | | 0.40 | 0.40 | 0.40 |
| | | Poly(meth)acrylate 1 | 0.25 | | | | | |
| | | Poly(meth)acrylate 2 | | | | | | |
| | | Amide-based friction-reducing agent | | | | 0.50 | | |
| | | Ester-based friction-reducing agent | | | | | 0.50 | |
| | | Ether-based friction-reducing agent | | | | | | 0.50 |
| | | Viscosity index improver | 7.50 | 7.50 | 7.50 | 7.50 | 7.50 | 7.50 |
| | | Zinc dialkyldithiophosphate A | 0.20 | 0.20 | 0.20 | 0.20 | 0.20 | 0.20 |
| | | Zinc dialkyldithiophosphate B | 1.20 | 1.20 | 1.20 | 1.20 | 1.20 | 1.20 |
| | | Antioxidant A | 0.50 | 0.50 | 0.50 | 0.50 | 0.50 | 0.50 |
| | | Antioxidant B | 0.50 | 0.50 | 0.50 | 0.50 | 0.50 | 0.50 |
| | | Metal-based detergent A | 1.20 | 1.20 | 1.20 | 1.20 | 1.20 | 1.20 |
| | | Metal-based detergent B | 1.00 | 1.00 | 1.00 | 1.00 | 1.00 | 1.00 |
| | | Polybutenyl succinic bisimide | 4.00 | 4.00 | 4.00 | 4.00 | 4.00 | 4.00 |
| | | Polybutenyl succinic bisimide boride | 1.00 | 1.00 | 1.00 | 1.00 | 1.00 | 1.00 |
| | | Other additives | 0.80 | 0.80 | 0.80 | 0.80 | 0.80 | 0.80 |
| Properties and performance | Kinematic | 40° C. [mm²/s] | 55.0 | 54.0 | 53.9 | 55.1 | 55.1 | 55.1 |
| of lubricating oil composition | viscosity | 100° C. [mm²/s] | 10.2 | 10.1 | 10.1 | 10.3 | 10.3 | 10.3 |

| | | | | | | |
|---|---|---|---|---|---|---|
| Viscosity index [—] | 176 | 177 | 176 | 178 | 178 | 178 |
| Molybdenum content [mass %] | 0.00 | 0.04 | 0.00 | 0.04 | 0.04 | 0.04 |
| Phosphorus content [mass %] | 0.11 | 0.11 | 0.11 | 0.11 | 0.11 | 0.11 |
| Sulfated ash content [mass %] | 1.02 | 1.06 | 1.02 | 1.06 | 1.06 | 1.06 |
| Frictional energy at liner temperature of 90° C. | 4.5 | 4.3 | 5.5 | 5.5 | 4.3 | 5.5 |
| [J/rotation] | | | | | | |
| Shell four-ball test (without carbon black) | 0.35 | 0.36 | 0.40 | 0.34 | 0.36 | 0.36 |
| Shell four-ball test (with carbon black) | 0.46 | 0.48 | 0.54 | 0.45 | 0.46 | 0.43 |

The base oil and the additives used are as follows.
(1) Hydrorefined base oil: 100 N, 40° C. kinematic viscosity; 19.6 mm²/s, 100° C. kinematic viscosity; 4.2 mm²/s, viscosity index; 122, aromatic content (% C_{A}); 0.0, sulfur content; less than 10 ppm by mass
(2) Organic molybdenum compound: sulfurized oxymolybdenum dithiocarbamate: tradename “SAKURA-LUBE 515” (manufactured by ADEKA Corporation), molybdenum content; 10.0 mass %, nitrogen content; 1.6 mass %, sulfur content; 11.5 mass %
(3) Poly(meth)acrylate 1 (copolymer of (a) 2-hydroxyethyl acrylate and (b) dodecyl acrylate, copolymerization ratio (molar ratio)=(a) 40:(b) 60, mass-average molecular weight: 70,000)
(4) Poly(meth)acrylate 2 (copolymer of (a) 2-hydroxyethyl acrylate and (b) dodecyl acrylate, copolymerization ratio (molar ratio)=(a) 40:(b)60, mass-average molecular weight: 30,000)
(5) Amide-based friction-reducing agent: oleyl diethanolamide
(6) Ester-based friction-reducing agent: glycerin monooleate
(7) Ether-based friction-reducing agent: polyglycerin monooleyl ether
(8) Viscosity index improver: olefin copolymer (mass-average molecular weight: 500,000)
(9) Zinc dialkyldithiophosphate A: Zn content; 8.9 mass %, phosphorus content; 7.4 mass %, primary alkyl-type zinc dialkyldithiophosphate
(10) Zinc dialkyldithiophosphate B: Zn content; 9.0 mass %, phosphorus content; 8.2 mass %, secondary alkyl-type zinc dialkyldithiophosphate
(11) Antioxidant A: amine-based antioxidant
(12) Antioxidant B: phenol-based antioxidant
(13) Metal-based detergent A: perbasic calcium salicylate [base number (JIS K 2501: perchloric acid method); 350 mgKOH/g, calcium content; 12.1 mass %]
(14) Metal-based detergent B: perbasic calcium salicylate [base number (JIS K 2501: perchloric acid method); 225 mgKOH/g, calcium content; 7.8 mass %]
(15) Polybutenyl succinic bisimide: number-average molecular weight of the polybutenyl group; 2,000, base number (perchloric acid method); 11.9 mgKOH/g, nitrogen content; 0.99 mass %
(16) Polybutenyl succinic monoimide boride: number-average molecular weight of the polybutenyl group; 1,000, base number (perchloric acid method); 25 mgKOH/g, nitrogen content; 1.23 mass %, boron content; 1.3 mass %
(17) Other additives: pour-point depressant, rust inhibitor, defoaming agent, and the like

The compositions of Examples 1 to 9 each serving as the lubricating oil composition of this embodiment were each obtained by incorporating the poly(meth)acrylate and the organic molybdenum compound specified in this embodiment into the base oil, and the frictional energy of each of the compositions in the floating liner test showed a low value under the condition of a liner temperature of 90° C.

Meanwhile, it was confirmed that the lubricating oil compositions obtained in Comparative Examples 1 and 3 each of which was free of any organic molybdenum compound had high frictional energies at a liner temperature of 90° C., and the wear resistance of each of the compositions deteriorated in the shell four-ball test. In addition, it was confirmed that the lubricating oil compositions of Comparative Examples 2 to 6 each of which was free of any poly(meth)acrylate also had high frictional energies at a liner temperature of 90° C., and the wear resistance of each of the compositions also deteriorated in the shell four-ball test. The same applied for the lubricating oil compositions of Comparative Examples 4 to 6 each of which was blended with a friction-reducing agent except the poly(meth)acrylate.

In addition, it was confirmed that the lubricating oil compositions of Examples 1 to 9 each expressed wear resistance more excellent than that of each of the lubricating oil compositions of Comparative Examples 1 to 6 even in the shell four-ball test in which a situation where soot had been included was reproduced by adding carbon black.

### INDUSTRIAL APPLICABILITY

The lubricating oil composition of this embodiment significantly reduces the friction of a sliding mechanism including a piston ring and a liner to contribute to a reduction in environmental load and an improvement in fuel efficiency. Accordingly, the composition can be suitably used as a lubricating oil for an apparatus having the sliding mechanism including the piston ring and the liner, in particular for an internal combustion engine.

### REFERENCE SIGNS LIST

1: floating liner friction tester
2: block
2a: piston-moving path
2b: crankshaft-housing space
4: piston
6, 8: piston ring
9: connecting rod
10: crankshaft
12: liner
14: load-measuring sensor
16: temperature gauge
18: fixing screw
20: lubricating oil composition

1. A lubricating oil composition to be used in an internal combustion engine having a sliding mechanism including a piston ring and a liner, the lubricating oil composition comprising:
a base oil;
(A) a poly(meth)acrylate; and
(B) an organic molybdenum compound,
wherein;
the poly(meth)acrylate (A) comprises a polymer (A1) including a repeating unit derived from a (meth)acrylate represented by the following formula (1) and having a mass-average modular weight of from 1,000 to 500,000; 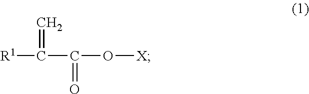
a content of (B) the organic molybdenum compound in a total amount of the composition is from 0.01 mass % to 0.20 mass % in terms of a molybdenum atom;
R¹ represents a hydrogen atom, or a methyl group; and
X represents a hydrogen atom, a hydrocarbon group having 1 to 60 carbon atoms, or a functional group-containing hydrocarbon group having 1 to 60 carbon atoms.

2. The lubricating oil composition according to claim 1, wherein a content of the poly(meth)acrylate (A) is from 0.01 mass % to 10 mass % with respect to the total amount of the composition.

3. The lubricating oil composition according to claim 1, wherein the organic molybdenum compound (B) comprises a molybdenum-amine complex, a molybdenum dithiocarbamate, a trinuclear molybdenum-sulfur compound, or a molybdenum dithiophosphate.

4. The lubricating oil composition recording to claim 1, wherein a ratio [content of (A) poly(meth)acrylate/content of (B) organic molybdenum compound in terms of molybdenum atom] of a content of the poly(meth)acrylate (A) to the content of the organic molybdenum compound (B) is from 1.0 to 50.

5. The lubricating oil composition according to claim 1, further comprising:
(C) an organic phosphorus compound.

6. The lubricating oil composition according to claim 5, wherein the organic phosphorus compound (C) comprises a zinc dialkyldithiophosphate or a zinc dialkyldioxophosphate.

7. The lubricating oil composition according to claim 1, wherein the lubricating oil composition has a sulfated ash content of 1.5 mass % or less with respect to the total amount of the composition.

8. The lubricating oil composition according to claim 1, wherein the base oil has a viscosity index of 120 or more.

9. The lubricating oil composition according to claim 1, wherein the lubricating oil composition has a phosphorus content of 0.18 mass % or less with respect to the total amount of the composition.

10. The lubricating oil composition according to claim 1, further comprising:
a polybutenyl succinimide, a polybutenyl succinimide boride, or both.

11. The lubricating oil composition according to claim 1, wherein X in the formula (1) represents a hydrocarbon group having 1 to 30 carbon atoms, or a group represented by any one of the following formulae (i), (ii), (iii), and (iv): 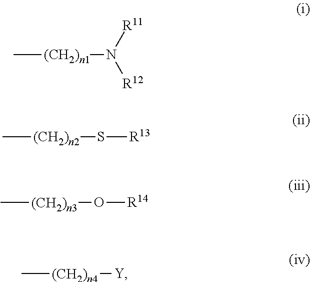
wherein:
R¹¹ to R¹⁴ each independently represent a hydrogen atom, a linear hydrocarbon group having 1 to 30 carbon atoms, a branched hydrocarbon group having 1 to 30 carbon atoms, a heteroatom-containing linear hydrocarbon group having 1 to 30 carbon atoms, or a heteroatom-containing branched hydrocarbon group having 1 to 30 carbon atoms;
n1 to n4 each independently represent an integer of from 1 to 30; and
Y represents an aryl group, a heterocyclic group, an ester group, an amide group, or a carbamate group.

12. The lubricating oil composition according to claim 11, wherein the poly(meth)acrylate (A) comprises a copolymer (A12) having a unit derived from a functional group-containing (meth)acrylate in which X in the formula (1) is represented by the formula (i), (ii), (iii), or (iv), and a unit derived from a hydrocarbyl (meth)acrylate in which X in the formula (1) represents a hydrocarbon group having 1 to 30 carbon atoms.

13. The lubricating oil composition according to claim 12, wherein a copolymerization between the functional group-containing (meth)acrylate and the hydrocarbyl (meth)acrylate in the poly(meth)acrylate is from 10:90 to 90:10 in terms of a molar ratio.

14. The lubricating oil composition according to claim 1, wherein the composition is adapted to function as a lubricating oil composition for a direct-injection engine.

15. An internal combustion engine, comprising a sliding mechanism including a piston ring and a liner, wherein the lubricating oil composition of claim 1 is present in a sliding portion of the sliding mechanism.

16. The internal combustion engine according to claim 15, wherein the piston ring has a sliding surface treated with chromium nitride.

17. The internal combustion engine according to claim 15, further comprising a supercharger.

18. The internal combustion engine according to claim 15, further comprising a cylinder fuel injector.

19. An internal combustion engine-lubricating method for lubricating a sliding mechanism including a piston ring and a liner in an internal combustion engine, the method comprising lubricating the piston ring and the liner with the lubricating oil composition of claim 1.

20. The internal combustion engine-lubricating method according to claim 19, wherein the piston ring has a sliding surface treated with chromium nitride.
